(19) United States
(12) Patent Application Publication
(10) Pub. No.: US 2015/0001884 A1
(43) Pub. Date: Jan. 1, 2015

(54) ONE PIECE FRONT HINGE PILLAR AND METHODS OF MAKING AND USING THE SAME

(71) Applicant: GM GLOBAL TECHNOLOGY OPERATIONS LLC, Detroit, MI (US)

(72) Inventors: Robert N. SAJE, Shelby Township, MI (US); Keith J. SAARI, Macomb Township, MI (US); Artur WYSZYNSKI, Oxford, MI (US); Terry A. SWARTZELL, Ann Arbor, MI (US)

(21) Appl. No.: 13/930,786

(22) Filed: Jun. 28, 2013

(51) Int. Cl. B62D 25/04; B22D 17/00

(52) U.S. Cl. CPC B62D 25/04; B22D 17/002
USPC 296/193.06; 164/113; 29/525.11

(57) ABSTRACT

A number of variations may include a product including a front hinge pillar for a vehicle, wherein the front hinge pillar is a non-joined, one piece of continuous cast material.

### TECHNICAL FIELD

The field to which the disclosure generally relates to includes front hinge pillars for vehicles.

### BACKGROUND

Heretofore front hinge pillars for vehicle have been made from two piece including a first piece having an out face with attachment features formed therein to attach body panels thereto and a second piece having an outer surface with attachment feature formed therein to attach structural components.

### SUMMARY OF ILLUSTRATIVE VARIATIONS

A number of variations may include a product including a front hinge pillar for a vehicle, wherein the front hinge pillar is a non-joined, one piece of continuous cast material.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a method of making a front hinge pillar for a vehicle, wherein the front hinge pillar is a non-joined, one piece of continuous cast material.

FIG. 2 illustrates a front hinge pillar including a tipped surface constructed and arranged for making a joint with another substrate according to a number of variations.

FIG. 3 illustrates a method of joining a first substrate having a tipped surface to a front hinge pillar utilizing a flow drill screw gun to insert a flow drill screw through the second substrate and through the front hinge pillar at the tipped surface.

FIG. 4 illustrates a front hinge pillar having a pocket formed therein by a plurality of wall portions according to a number of variations.

FIG. 5 illustrates a front hinge pillar having a first side including a pocket constructed and arranged to receive the pointed end of a flow drill screw according to a number of variations.

FIG. 6 illustrates a second side of the front hinge pillar shown in FIG. 5 and wherein the second side includes tipped surfaces for adjoining to another substrate according to a number of variations.

FIG. 7 illustrates a front hinge pillar including a double-sided attachment pocket having opposing tipped surfaces each for forming a joint with another substrate according to a number of variations.

FIG. 8 illustrates a front hinge pillar having a plurality of tipped surfaces constructed and arranged to provide double-sided reverse pockets according to a number of variations.

### DETAILED DESCRIPTION OF ILLUSTRATIVE VARIATIONS

The following description of the variations is merely illustrative in nature and is in no way intended to limit the scope of the invention, its application, or uses.

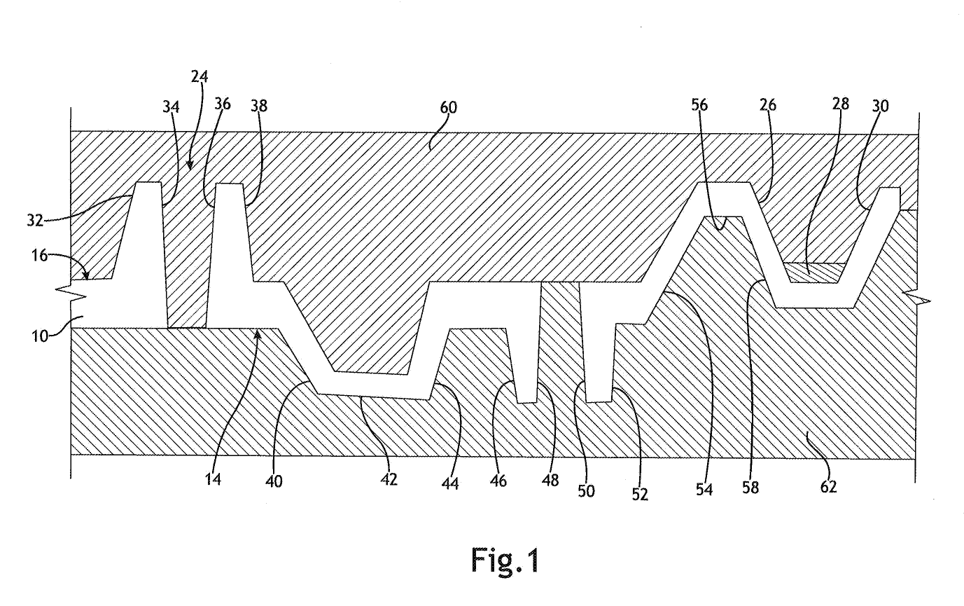

Referring now to FIG. 1, a number of variations may include a method of making a front hinge pillar for a vehicle, wherein the front hinge pillar is a non-joined, one piece of continuous cast material 10. The front hinge pillar is a non-joined, one piece of continuous cast material 10 and may be made by a method including providing a casting die 159 having a first half 160 and an opposite second half 162, wherein each die half 160, 162 is configured to form features in each of a first face and a second opposite face of the front hinge pillar.

The front hinge pillar 10 may include a first face 116 and opposite second face 118. The front hinge pillar 10 may be an elongated structure having a length long than a width. The first face 116 may include a plurality of features 172, 178 formed therein for attaching vehicle body panel or structural components thereto. The second face 118 of front hinge pillar 10 may include a plurality of features 174, 176, 180 formed therein for attaching vehicle body panel or structural components thereto. The features 172, 174, 176, 178 and 180 on the first face 116 and second face 118 may be formed with surfaces that are slanted with respect to a line normal (perpendicular) to a reference plane through the length or width of the front hinge pillar, and wherein the line normal to the reference plane is parallel to a line A of the direction die half 160 draw or the line B of the direction of die half 162 draw. For example a mounting through hole feature 173 may be cast in the first face 116 and may be defined by surface 132,134, 136 and 138 which are slanted with respect to line A. Attachment feature 178 may be defined at least in part by surface 182 1nd 184 which are slanted with respect to line A. Pocket 118 may be defined at least in part by surfaces 190, 192 194 which are slanted, and pocket 196 may be define at least in part by surface 184, 128 and 130 which are slanted with respect to line A. In the second face 118, attachment feature 174 may be defined at least in part by surfaces 140, 142, 144 which are slanted with respect to line B. Through hole 176 may be define at least in part by surfaces 146, 148, 150 and 152 with respect to line B. Pocket feature 198 may be defined at least in part by surfaces 154, 156, 158 with respect to line B. Attachment feature 180 may be defined at least in part by surfaces 158, 186 with respect to line B. The slanted surfaces provide draft angles to facilitate opening of the casting die 159 and movement in direct of line A of the first die half 160 and/or movement in the direction of line B of the second die half 162 or movement of the solidified cast front hinge pillar in the direction or line A or B to release the cast front hinge pillar from the die 159.

A number of variations may include a method including casting a front hinge pillar for a vehicle in a casting die, the cast front hinge pillar being a non-joined, one piece of continuous cast material and wherein the casting die includes a first die half and an opposite second die half, the first die half and the second die half each being configured to form a plurality of attachment features in one of a first face and a second opposite face, respectively, of the front hinge pillar, the plurality of features formed in the first face and second face being formed with surfaces that are slanted with respect to a line normal (perpendicular) to a reference plane through the length or width of the front hinge pillar, and wherein the line normal to the reference plane is parallel to a line of the direction first die half 160 draw or the line B of the direction of the second die half 162 draw, casting molten metal into the die and solidifying the metal, withdrawing at least one of the first die half or second die half and releasing the cast front hinge pillar.

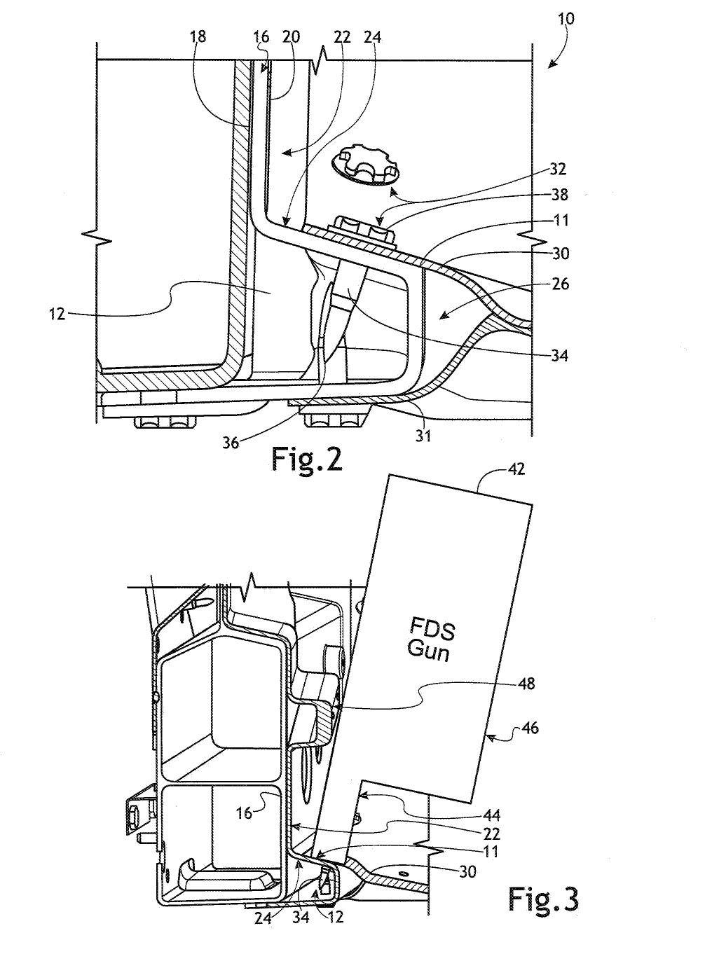

Referring now to FIG. 2, a number of variations may include product 10 which may include a substrate having a tipped surface 11 constructed and arranged for making a joint with another substrate. In a number of variations, the product 10 may be constructed and arranged to define a pocket 12 for receiving the sharp end of a fastener. In a number of variations, the product 10 may include a substrate 16 having a first inner face 18 and an opposite outer face 20. The substrate 16 may include a first wall portion 22 which joins a second wall portion 24 which joins a third wall portion 26 which joins a fourth wall portion 28. The first wall portion 22, second wall portion 24, third wall portion 26 and fourth wall portion 28 may define, at least in part, the pocket 12 for receiving a fastener. In a number of variations the substrate 16 may be a casting such as, but not limited to, a high pressure die-casting of an aluminum alloy. In a number of variations, the first wall portion 22 has an outer face 20 having a straight portion, which has formed an obtuse angle with respect to the outer face of the second portion 24.

As will be appreciated from FIG. 3, the tipped surface 11 of the second portion 24 may be constructed and arranged to allow a flow drill screw gun to insert a flow drill screw 32 through the first substrate 16 and a second substrate 30 wherein the flow drill screw is drilled into the tipped surface 11 of the second wall portion 24. The flow drill screw gun 40 may include a narrow portion 44 which drives a head 38 of the flow drill screw 32 so that a pointed tip 36 at the end of a shaft 34 pierces the second substrate 30 and the second wall portion 24 of the first substrate and any adhesive layer interposed between the first substrate 16 and second substrate 30. The second portion 24 of the first substrate 16 may be constructed and arranged and tipped so that the wider upper portion 46 of the flow drill screw gun 42 avoids contact with the first portion 22 of the substrate 16 and any other protrusions 48 of the first substrate 16.

Referring again to FIG. 2, a second flow drill screw 40 may be utilized to pierce a third substrate 31 and the fourth wall portion 28 of the first substrate 16 to attach the third substrate 31 to the first substrate 16. In a number of variations, the first substrate 16 may be a front hinge pillar of a vehicle, the second substrate may be a steel vehicle dash panel and the third substrate may be a floor panel of the vehicle.

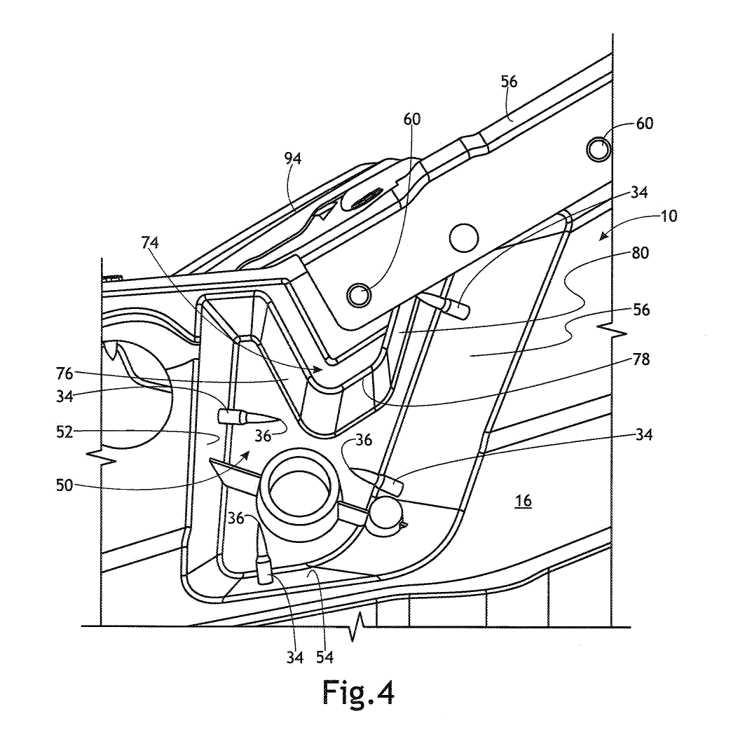

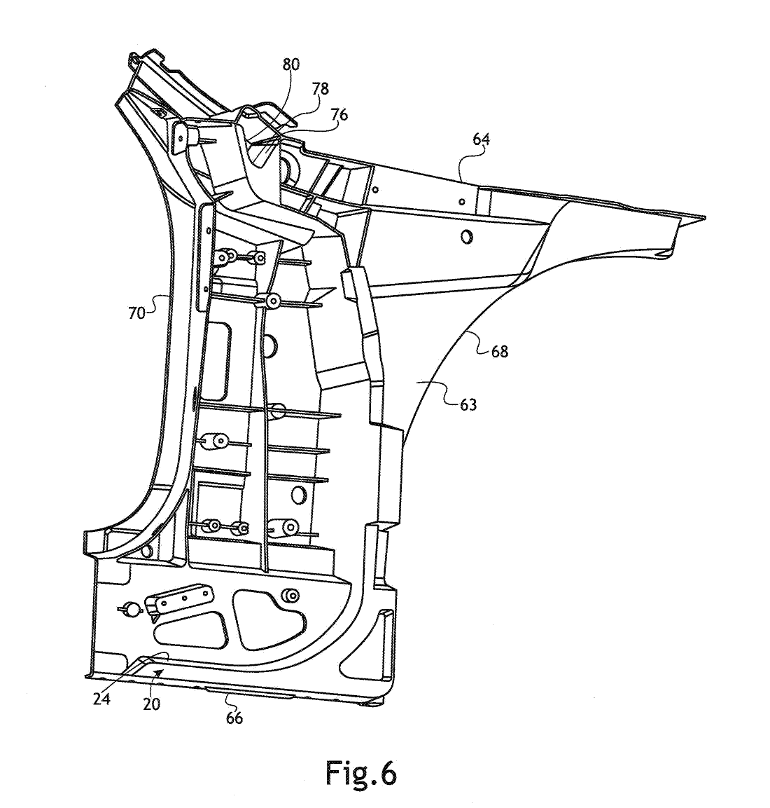

Referring now to FIG. 4, in a number of variations the product 10 may include a first substrate 16 which is constructed and arranged to define a second pocket 50 for receiving a portion of each of a plurality of flow drill screws 32. The second pocket 50 may be defined, at least in part, by a first wall portion 52 joining a second wall portion 54 joining a third wall portion 56. The first wall portion 52 may have an outer planar face formed at an acute angle with an outer planar face of the second wall portion 54, and the third wall portion 56 may have an outer planar face formed at an obtuse angle with respect to the outer planar face of the second wall portion 54. The outer planar face of the third wall portion 56 may also be tilted or skewed with respect to the outer planar face of the second wall portion 54. Each of the first wall portion 52, second wall portion 54, and third well portion 56 may include an opposite inner face formed in the opposite side 18 of the substrate 16 (shown in FIG. 2) and which is generally parallel to the outer face of each of the wall portions 52, 54, and 56. A raised feature 74 may be provided in the substrate 16 and may include a first wall portion 76, second wall portion 78 and third wall portion 80 which define in the opposite face 18 a third pocket 72 best seen in FIG. 6.

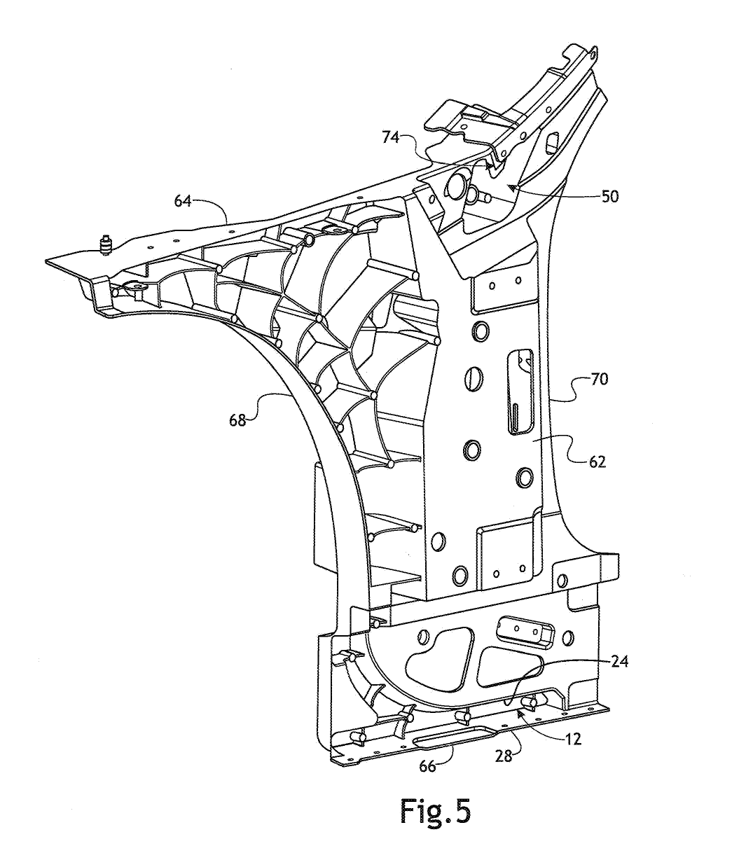

Referring now to FIGS. 5-6, the product 10 may include a single piece casting in the form of a cast front hinge pillar which may include a top edge 64 and opposite bottom edge 66, a first arcuate or curved surface 68 constructed and arranged to define, at least in part, a vehicle wheel well, and an opposite second arcuate or curved surface 70 constructed and arranged to define, at least in part, a door well of a vehicle. Because features in the first face 62 and second face 63 of the cast front hinge pillar include tipped or tilted surfaces, or surfaces that are slanted with respect to the direction of movement of casting die halves or the direction of movement of the cast product upon release from the cast die, the front hinge pillar can be cast in a molding die so that a first die half associated with the first face 62 may be easily removed and similarly a second die half associated with forming the second face 63 may be easily removed after molten alloy has been cast in the die and solidified. The tipped or tilted surfaces or slanted surfaces do not catch on the mold die halves as the halves are opened to release the cast product or the solidified cast product is removed from the die.

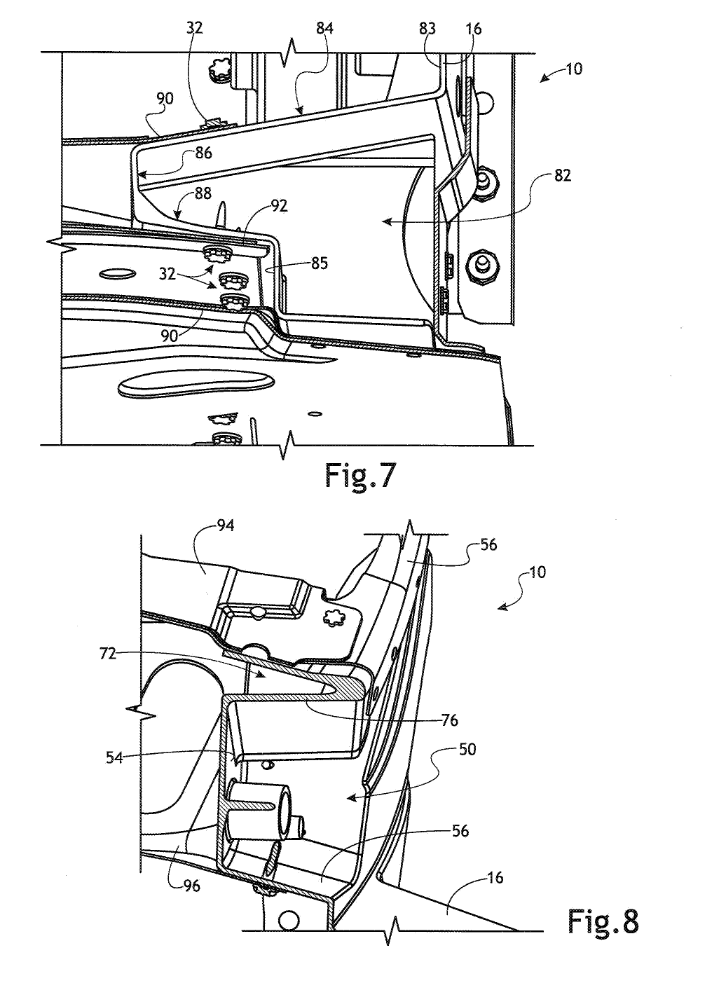

Referring now to FIG. 7, in a number of variations the product 10 may include a substrate constructed and arranged to provide a third pocket 82 which may be a double sided attachment pocket which may be formed by a second wall portion 84 joining a third wall portion 86 joining a fourth wall portion 88. The second wall portion 84 has a planar face formed at an obtuse angle with respect to a planar face of a first wall portion 83. The second wall portion 84 may include an outer surface having a planar face which is formed at an obtuse angle with an outer surface having a planar face of the third wall portion 86. Similarly, the fourth wail portion 88 may include an outer surface having a planar face which has formed at an obtuse angle with an outer planar face of the third wall portion 86. The tipped surfaces of the second wall portion 84 and fourth wall portion 88 allow for the attachment of a first sheet 90 to the second wall portion 86 using a flow drill screw 32 and the attachment of a second sheet of material 92 to the fourth wall portion 88 utilizing a flow drill screw 32.

Referring now to FIG. 8, in a number of variations, the product 10 may include a substrate 16 constructed and arranged to provide double sided reverse pockets 50 and 72 which share a common wall portion 76. A number of sheets of other material 94, 96 may be attached to the substrate 16 on either or both faces thereof and at a variety of angles utilizing the wall portion defining the reverse pockets 50 and 72.

The following description of variants is only illustrative of components, elements, acts, product and methods considered to be within the scope of the invention and are not in any way intended to unit such scope by what is specifically disclosed or not expressly set forth. The components, elements, acts, product and methods as described herein may be combined and rearranged other than as expressly described herein and still are considered to be within the scope of the invention.

Variation 1 may include a product comprising a cast front hinge pillar for a vehicle comprising a first face and opposite second face, the first face including a plurality of features formed therein for attaching vehicle body panel or vehicle structural components thereto, the second face of front hinge pillar including a plurality of features formed therein for attaching vehicle body panel or vehicle structural components thereto, the plurality of features formed in the first face and second face being formed with surfaces that are slanted with respect to a line normal (perpendicular) to a reference plane through the length or width of the front hinge pillar, the cast front hinge pillar being a non-joined, one piece of continuous cast material.

Variation 2 may include a product as set forth in Variation 1 wherein the cast material comprises an aluminum alloy.

Variation 3 may include a product comprising. a cast front hinge pillar including a first face and an opposite second face, the first face of the cast front hinge pillar including a first wall portion joining a second wall portion, the first wail portion having an outer surface having a planar face, a second wall portion having an outer surface having a planar face formed at an obtuse angle to the planar face of the first wall portion and constructed and arranged to facilitate attachment of a second substrate to the second wall portion using a flow drill screw driven by a flow drill screw gun, the cast front hinge pillar being a non-joined, one piece of continuous cast material.

Variation 4 may include a product as set forth in Variation 3, further comprising a third wall portion joining the second wall portion and a fourth wall portion joining the third wall portion, and wherein the second wall portion, third wall portion and fourth wall portion define, at least in part, a pocket for receiving a portion of a fastener.

Variation 5 may include a product as set forth in Variation 4, further comprising a second pocket formed in the opposite second face of the cast front hinge pillar, the second pocket being defined at least in part by a fifth wall portion, a sixth wall portion and a seventh wall portion.

Variation 6 may include a product as set forth in any of Variations 3-5, wherein the second face of the cast front hinge pillar has a second pocket formed therein wherein the first pocket and second pocket are defined at least in part by a common wall portion.

Variation 7 may include a product as set forth in any of Variations 2-6, wherein the third wall portion includes an outer surface having a planar face and wherein the fourth wall portion has an outer surface having a planar face, and wherein the planar face of the fourth wall is formed at an obtuse angle with respect to the planar face of the third wall portion so that the second wall portion and the fourth wall portion provide opposite attachment surfaces each for the insertion of a fastener therethrough.

Variation 8 may include a product as set forth in any of Variations 1-7 wherein the cast front hinge pillar comprises a high pressure die-casted aluminum alloy.

Variation 9 may include a method comprising: casting a front hinge pillar for a vehicle in a casting die, the cast front hinge pillar being a non-joined, one piece of continuous cast material and wherein the casting die includes a first die half and an opposite second die half, the first die half and the second die half each being configured to form a plurality of attachment features in one of a first face and a second opposite face, respectively, of the front hinge pillar, the plurality of features formed in the first face and second face being formed with surfaces that are slanted with respect to a line normal (perpendicular) to a reference plane through the length or width of the front hinge pillar, and wherein the line normal to the reference plane is parallel to a line of the direction first die half draw or the line of the direction of the second the half draw, casting molten metal into the die and solidifying the metal, withdrawing at least one of the first die half or second die half and releasing the cast front hinge pillar.

Variation 9 may include a method comprising: providing a cast front hinge pillar for a vehicle, the cast front hinge pillar being a non-joined, one piece of continuous cast material and including a first face and an opposite second face, the substrate including a first wall portion joining a second wall portion, wherein the first wall portion includes an outer surface having a planar face and wherein the second wall portion includes an outer surface having a planar face and wherein the planar face of the second wall portion is formed at an obtuse angle to the planar face of the first wall portion; attaching a second substrate to the cast front hinge pillar comprising placing the second substrate over the planar face of the second wall portion and inserting a flow drill screw through the second substrate and the second wall portion at the planar face thereof to provide a joint between the cast front hinge pillar and the second substrate, wherein the inserting a flow drill screw through the second substrate and the second wall portion at the planar face thereof comprises driving the flow drill screw with a flow drill gun operated so that the flow drill screw gun does not contact the first wall portion during the driving the flow drill screw. The above description of select variations within the scope of the invention is merely illustrative in nature and, thus, variations or variants thereof are not to be regarded as a departure from the spirit and scope of the invention.

1. A product comprising a cast front hinge pillar for a vehicle comprising a first face and opposite second face, the first face including a plurality of features formed therein for attaching vehicle body panel or vehicle structural components thereto, the second face of front hinge pillar including a plurality of features formed therein for attaching vehicle body panel or vehicle structural components thereto, the plurality of features formed in the first face and second face being formed with surfaces that are slanted with respect to a line normal (perpendicular) to a reference plane through the length or width of the front hinge pillar, the cast front hinge pillar being a non-joined, one piece of continuous cast material.

2. A product as set forth in claim 1 wherein the cast material comprises an aluminum alloy.

3. A product comprising:
a cast front hinge pillar including a first face and an opposite second face, the first face of the cast front hinge pillar including a first wall portion joining a second wall portion, the first wall portion having an outer surface having a planar face, a second wall portion having an outer surface having a planar face formed at an obtuse angle to the planar face of the first wall portion and constructed and arranged to facilitate attachment of a second substrate to the second wall portion using a flow drill screw driven by a flow drill screw gun, the cast front hinge pillar being a non-joined, one piece of continuous cast material.

4. A product as set forth in claim 3, further comprising a third wall portion joining the second wall portion and a fourth wall portion joining the third wall portion, and wherein the second wall portion, third wall portion and fourth wall portion define, at least in part, a pocket for receiving a portion of a fastener.

5. A product as set forth in claim 4, further comprising a second pocket formed in the opposite second face of the cast front hinge pillar, the second pocket being defined at least in part by a fifth wall portion, a sixth wall portion and a seventh wall portion.

6. A product as set forth in claim 3, wherein the second face of the cast front hinge pillar has a second pocket formed therein wherein the first pocket and second pocket are defined at least in part by a common wall portion.

7. A product as set forth in claim 4 wherein the third wall portion includes an outer surface having a planar face and wherein the fourth wall portion has an outer surface having a planar face, and wherein the planar face of the fourth wall is formed at an obtuse angle with respect to the planar face of the third wall portion so that the second wall portion and the fourth wail portion provide opposite attachment surfaces each for the insertion of a fastener therethrough.

8. A product as set forth in claim 3 wherein the cast front hinge pillar comprises a high pressure die-casted aluminum alloy.

9. A method comprising:
casting a front hinge pillar for a vehicle in a casting die, the cast front hinge pillar being a non-joined, one piece of continuous cast material and wherein the casting die includes a first die half and an opposite second die half, the first die half and the second die half each being configured to form a plurality of attachment features in one of a first face and a second opposite face, respectively, of the front hinge pillar, the plurality of features formed in the first face and second face being formed with surfaces that are slanted with respect to a line normal (perpendicular) to a reference plane through the length or width of the front hinge pillar, and wherein the line normal to the reference plane is parallel to a line of the direction first die half draw or the line of the direction of the second die half draw, casting molten metal into the die and solidifying the metal, withdrawing at least one of the first die half or second die half and releasing the cast front hinge pillar.

10. A method comprising:
providing a cast front hinge pillar for a vehicle, the cast front hinge pillar being a non-joined, one piece of continuous cast material and including a first face and an opposite second face, the substrate including a first wall portion joining a second wall portion, wherein the first wall portion includes an outer surface having a planar face and wherein the second wall portion includes an outer surface having a planar face and wherein the planar face of the second wall portion is formed at an obtuse angle to the planar face of the first wall portion;
attaching a second substrate to the cast front hinge pillar comprising placing the second substrate over the planar face of the second wall portion and inserting a flow drill screw through the second substrate and the second wall portion at the planar face thereof to provide a joint between the cast front hinge pillar and the second substrate, wherein the inserting a flow drill screw through the second substrate and the second wall portion at the planar face thereof comprises driving the flow drill screw with a flow drill gun operated so that the flow drill screw gun does not contact the first wall portion during the driving the flow drill screw.
